(19) United States
(12) Patent Application Publication
(10) Pub. No.: US 2004/0187148 A1
(43) Pub. Date: Sep. 23, 2004

(54) Methods and computer program for multimedia interaction

(76) Inventor: Anthony Cassella, Cushing, ME (US)

Correspondence Address: Lawson & Persson, P.C., Suite 103, 67 Water Street, Laconia, NH, 03246, US

(21) Appl. No.: 10/782,048

(22) Filed: Feb. 19, 2004

Related U.S. Application Data
(60) Provisional application No. 60/456,013, filed on Mar. 19, 2003.

(51) Int. Cl. H04N 5/445; G06F 3/00; H04N 7/10; H04N 7/025; H04H 9/00; H04N 7/16; G06F 13/00

(52) U.S. Cl. 725/35; 725/34; 725/9; 725/14; 725/135

(57) ABSTRACT

A method for multimedia interaction between viewers and a broadcaster, a computer program product for executing the method for multimedia interaction, and a method for attracting additional subscribers to network service providers through use of this method. The method for multimedia interaction includes the steps of establishing a communication link between a plurality of viewers and broadcaster and choosing at least one viewer to appear on a broadcast. Once chosen, the viewer or viewer receives digital image and audio, or video, information from the broadcaster and transmits digital image and audio, or video, information back to the broadcaster. At least a portion of the video information transmitted to the broadcaster is included in the broadcast, which is then transmitted to at least the plurality of viewers from which the chosen viewer or viewers were chosen via digital picture with live information via Internet.

### CLAIM OF PRIORITY

This application claims the benefit of priority of U.S. Provisional Patent Application Serial No. 60/456,013, filed Mar. 19, 2003.

### FIELD OF THE INVENTION

The present invention relates to the field of entertainment and, in particular, to methods of facilitating dynamic user input to change the content of a broadcast television program and to business methods for expanding subscription bases for network service providers using such methods.

### BACKGROUND OF THE INVENTION

Television programs, and other forms of modern mass media, constantly seek to increase viewers and advertising revenues from their broadcasts. The two principal ways in which this is accomplished is to increase the size of the audience to be reached by advertisers on the program or to target a specific demographic that is more likely to buy the types of products advertised by the show.

Current television programs have attempted to increase audience size by making the show more interesting through interaction with the audience. In addition, “reality” television has become a very popular genre, and appears to become more sought after every day.

The game show genre has, for many years, used the interesting tactic of providing avenues for audience member participation in order to increase interest in, and viewership of, the program. At the highest level of participation, game shows of the past and present have directly chosen participants from the audience. Examples of this are “The Price is Right”, in which audience members are invited to “Come on down and be the next contestant”. This ability to be on television and to “win fabulous prizes” generated interest in attending the program, and for friends and family members of those chosen to watch the program as well. However, those members of the television audience who could not travel to California to attend the show in person, or who had no personal interest in a contestant, were unaffected by this audience participation and were not drawn to watch the program for this reason. Thus, a large percentage of people would like to appear cannot as they have neither the time nor the money to do so.

Other television programs have used audience participation as a means for judging or assisting the contestants. Example of such programs are “America's Funniest Home Videos” in which the audience votes on the best video of the show, and “Who Wants to Be a Millionaire”, where the contestant can “ask the audience” to provide an answer to a question. Again, the audience appeal for these shows was limited to those people who traveled to the studio where the program was taped. Therefore, the appeal to home viewers was unaffected by the audience's participation in the outcome and was limited to the audience in the studio.

Recently, telephone-television program hybrids, which encourage text message voting, have become extremely popular in Europe. News programs encourage text comments. Game shows allow phone competitions between viewers. Music shows take requests by text messaging. Further, many programs show messages related to the program. Fusing television programs with telephone functions has resulted in increased profits of both industries. However, these programs are not without their shortcomings.

Text messaging, and its use in television, is not a new concept. For example, one version of text message use is shown in U.S. Pat. No. 5,537,143, which describes an Interactive Communication System that solves the problem of enabling a participant to participate in a broadcast program event by using a dual-tone telephone. The broadcast program event may be viewed on a television receiver simultaneously with other participants, while the computer is driven by a plurality of DTMF receivers. The participant gains access to a DTMF receiver through a conventional telephone circuit terminating at a local telephone exchange (LTE). The participant is prompted by the program event to enter responses into the computer through the DTMF receiver by pressing keys on the keypad. The DTMF receiver has a digital character output. A microprocessor processes the output and sends it to a main memory when enabled by associated logic. Viewer identification software associates the responses with the participant and a time stamp is attached. Criteria software sorts and evaluates the responses according to criteria instructions. Judging software selects a winner according to judging instructions. Winner(s) selection software supplies winner identification for announcement by the transmitting station. The broadcast program event may include commercial messages offering incentives to purchase merchandise and services or include offers of prizes to the participant.

While the programs noted above allow a user to participate in a broadcast program event, the participation is fairly limited. Interaction can never truly be dynamic due to the cumbersome nature of text messaging, and without live personal input and appearance. Pressing buttons to communicate dynamically is highly artificial, and effective communication demands at least a human audio component. However, to provide full dynamic interaction, a broadcast should provide a viewer visual and audible component that does not require the viewer to focus attention away from the action to read messages. Finally, it is noted that viewing one's text message on the screen does not provide the same impetus for audience participation as having one's “live” interacting digital or video picture and voice on a program, and this format certainly does not encourage friends and family members to watch. Accordingly, the inventor believes that the appeal of these programs will soon wane.

The telephone is no longer the sole method of instantaneous communication. In this current telecommunication age, massive documents, images, audio tracks, and movies may be transferred via the Internet with complete disregard for distance. While distance is non-factor, speed typically constrains most systems. The largest barrier to uninhibited communication is the speed at which data can be transferred. This awaiting market has compelled electronics giants to develop faster communication components, which now allow a user visual as well as lo audio communication over transfer lines; i.e. telephone/DSL lines and/or cable lines/or satellite. However, this enhanced functionality has not yet been fully exploited by the entertainment industry.

U.S. Pat. No. 6,240,555 describes an interactive entertainment system that enables presentation of supplemental interactive content alongside traditional broadcast video prams, such as television shows and movies. The programs are broadcast in a conventional manner. The supplemental content is supplied as part of the same program signal over the broadcast network, or separately over another distribution network. A viewer's computing unit is located at the viewer's home to present the program and supplemental content to a viewer. When the viewer tunes to a particular channel, the viewer's computing unit consults an electronic programming guide (EPG) to determine if the present program carried on the channel is interactive. If it is, the viewer's computing unit launches a browser. The browser uses a target specification stored in the EPG to activate a target resource containing the supplemental content for enhancing the broadcast program, downloads the data from the target resource, and displays the supplemental content concurrently with the video content program.

This patent discloses a mode for a viewer to experience a program in greater depth, but this experience is purely supplemental. Trivia, games, or behind-the-scenes content might make for great entertainment, yet the viewer wields no control over the original program content or the opportunity to appear on the program. Interaction here relates to the supplemental material, not to the primary material, i.e. the program itself, and the user's identity is not merged into the broadcast. Further, this patent requires the viewer to again draw attention away from the action to read the supplemental data. Finally, the viewer is a viewer and does not give “live” input.

Other patents disclose methods for real-time competition between program viewers. For example, U.S. Pat. No. 6,193,610 describes an interactive apparatus and method that allows participants to compete in an interactive game, such as a contest or sporting event, occurring in real time, or as a taped broadcast of a real time event. The event with which the participant may interact is broadcast live, or previously taped but not aired. At home, participants can play along with the broadcast on a real time basis as a previously taped segment of the television show is aired. Interactive play may be accomplished by access to an on-line version of the game, while the corresponding game show airs live, or is rebroadcast to the participant for the first time on television.

As was the case with the other attempts at interactivity, the interactive play recited in the above-mentioned patent is supplemental in nature and viewer input does not affect program content in any recognizable fashion. Further, there is no visual or audio interaction between the players, except in each viewer's realm of fantasy as the characters are not real.

U.S. Pat. No. 6,447,396 describes an interactive computer game with a television broadcast, a central control establishes a large virtual environment in which viewers participate with characters either controlled or designed by them. Each user can directly control or influence characters within an “active region” which encompasses part of the virtual environment that is much less than the total environment. The broadcast portion of the system also has an active region, at least a portion of which is shown on a broadcast television show. The locations of the active regions are controlled by the central control. In accordance with one embodiment, the central control moves the active regions of selected users so that these active regions coincide or overlap the broadcast active region. The selected users are then allowed to control characters that appear on the broadcast television show. In accordance with another embodiment, the central control may transport characters created by a user from the user's active region to the broadcast active region by means of a virtual “portal.”

While the interactive play recited in the above-mentioned patent is not supplemental in nature and the input recognizably effects program content, the visual component is not that of the viewer. Instead, the viewer acts a virtual puppeteer that manipulates an imaginary character. Audience members want to see themselves on television, not fantasy depictions that happen to depend on their input.

Other concepts to fuse the Internet with television programming have also been patented. For example, U.S. Pat. No. 6,431,985, issued Aug. 13, 2002, describes an evaluation system for the fairness about the judgment of referees and the management of coaching staffs in a sports game via Internet and providing data thereof. The data of the judgments of referees who control games, coaching staff management, and scenes of doubtful fairness are stored in an additional database to be transmitted in real time when information is requested from each terminal, game management records of the referees and the coaching staffs are continuously monitored, evaluation result values about the fairness and pertinence of the records are stored as data.

While this patent allows a user to interact with a television program, the user's contribution is purely trivial. The program does not recognize the data in an effort to interact with the user and neither the user's identity nor likeness or digital “live” image is projected into the program. Rather, this patent merely delivers a forum to express an opinion.

Therefore there is a need for a method that will increase advertising revenues generated by a broadcast and, therefore, a need to enhance the viewership of a broadcast by allowing viewers from anywhere in the world to be chosen to appear live digitally on the broadcast in substantially real time and offer input regarding program content.

### SUMMARY OF THE INVENTION

The present invention is a method for multimedia interaction between viewers at home, or at any other remote location, and a broadcaster, in which the digital image and voice, or video, of at least one viewer appears on the television or cable program via internet carrier and in which the viewer is able to participate and give immediate direct input and reactions to the program. In addition, the present invention includes a computer program product for executing the method for multimedia interaction, and a method for attracting additional subscribers to network service providers through use of this method.

The method for multimedia interaction includes the steps of establishing a communication link between a plurality of viewers and broadcaster and choosing at least one viewer to appear on a broadcast. Once chosen, the viewer or viewer receives video and/or digital picture and audio information from the broadcaster via a network, preferably the Internet, and transmits video and/or digital picture and audio information back to the broadcaster. At least a portion of the video information transmitted to the broadcaster is included in the broadcast. The broadcast is then transmitted to at least the plurality of viewers from which the chosen viewer or viewers were chosen.

In the preferred method, a network administrator provides a broadband communications link between the viewers and the broadcaster, and assists in the choice of the viewer or viewers who will participate in the broadcast. In the preferred embodiment, this assistance includes a certification that the viewer's hardware will provide a sufficiently clear “live” image to the broadcaster. As used herein, the term “live image” is defined as an image that has the appearance of being “in-person”, and includes videotaped, digitally captured and/or directly broadcasted images, whether broadcasted in real time or on time delay. In some embodiments, the network administrator will choose particular viewers based upon prior actions, such as frequent viewing of the program or patronage of sponsors. In still, others, the network administrator provides a pool of potential viewers for the broadcaster to interview and choose from. Viewers can be interviewed by using the same process, which will enable viewer participation and activity prior to the show without the large cost the shows have expended in the past.

The preferred type of broadcast for the method is a game show type broadcast, in which the viewer may win cash or other prizes. However, the method is readily adaptable to other program formats, such as news, where the ability to choose from viewers worldwide is advantageous.

In one embodiment, the method is adapted for use in interactive gaming, in which viewers may appear on a real time broadcast of a game of chance and wager, along with other viewers, on this game of chance, participating live from home with the same effectiveness as a contestant in the studio.

In other embodiments, a plurality of viewers are be chosen to “direct” the action taking place in a scene, with each appearing on screen and choosing a particular direction for the action to take.

The method for multimedia interaction of the present invention is readily adapted for execution by a computer program product. In its most basic form, the program product includes program means for establishing a communication link between a plurality of viewers and broadcaster, program means for choosing at least one viewer to appear on a broadcast, program means for sending and receiving digital image and audio information n between a broadcaster and a chosen viewer, and means for transmitting the resulting broadcast to at least the plurality of viewers from which the chosen viewer or viewers were chosen.

The present invention also includes the use of the method for multimedia interaction of the present invention as part of a method for increasing network subscriber-ship practiced by the network service providers. The method for increasing network subscriber-ship includes the steps of obtaining a right to provide participants to a broadcaster of a program and informing potential viewers of the ability to participate in broadcasts of the program by subscribing to the network. The network provider then performs the method for method for multimedia interaction by establishing a communication link between a plurality of viewers and broadcaster and choosing at least one viewer to appear on a broadcast, transmitting image and audio information between the viewer and broadcaster, and transmitting the broadcast to at least the plurality of viewers from which the chosen viewer or viewers were chosen.

Using the methods of the present invention, a person can be transported to any television show location to appear and participate as if they were really in the studio. This gives the television show the opportunity to have individuals from any part of the world interact with their show at any time. In addition, it provides show producers with a means to not only interview individuals, but to allow for inexpensive auditions of contestants prior to actually appearing in person on the show.

Therefore, it is an aspect of the invention to provide a method for increasing the advertising revenues generated by a broadcast.

It is a further aspect of the invention to provide a method for increasing subscriptions to a network service provider.

It is a further aspect of the invention to provide a method that enhances the viewership of a broadcast.

It is a further aspect of the invention to provide a method that provides incentives for viewers to watch and/or patronize the broadcast's sponsors.

It is a further aspect of the invention to provide a method that allows viewers from anywhere in the world to be chosen to participate “live” from a remote location.

It is a further aspect of the invention to provide a method that allows remote viewers to appear on the broadcast in substantially real time.

It is a further aspect of the invention to provide a method that is readily adapted for execution by a computer program product.

It is a further aspect of the invention to provide a method that allows remote viewers to play, and/or wager on, a game that is broadcast to other viewers.

It is a further aspect of the invention to provide a method that allows network providers to increase their number of subscribers.

It is still a further aspect of the invention to provide a method that allows network providers to provide customized content to its subscribers.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a block diagram showing the preferred network arrangement for performing the method.

FIG. 2 is a block diagram showing the program blocks of the computer program product of the present invention.

FIG. 3 is a block diagram showing the steps of one embodiment of the method for increasing subscribers to a network.

### DETAILED DESCRIPTION OF THE INVENTION

As noted above, the method for multimedia interaction includes the steps of establishing a communication link between a plurality of viewers and broadcaster and choosing at least one viewer to appear on a broadcast. Once chosen, the viewer or viewers receives digital image and audio information, preferably via the Internet, from the broadcaster and transmits live digital image and audio information back to the broadcaster. This can be recorded or used live, whichever the show prefers. At least a portion of the video information transmitted to the broadcaster is included in the broadcast, which is then transmitted to at least the plurality of viewers from which the chosen viewer or viewers were chosen.

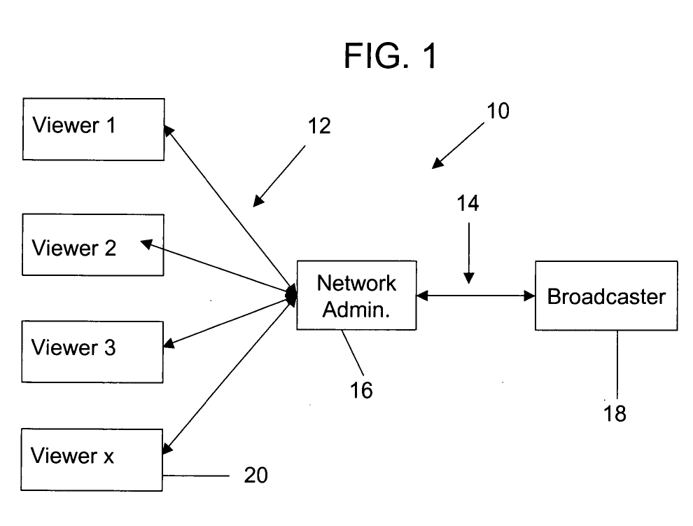

As shown in FIG. 1, in the preferred method the viewers 20 establish a communication link to the broadcaster 18 via a virtual private network 10, in which only subscribers to the network have access. The preferred communications link between the viewer 20 and the network administrator 16 is a broadband link 12, such as a cable or DSL modem link. This is preferred in order to insure that the video transmitted and received from the chosen viewer will appear to be substantially “real time”, without the delays and poor image quality that are attendant to dial-up connections. However, it is understood that compression software technology is advancing rapidly and that video data may, eventually, be sufficiently compressed to allow dial-up connections to provide similar results to those of conventional broadband communications links. Accordingly, the method should not be so limited. It is likewise recognized that satellite communications could be utilized, although the cost and availability of this means makes it non-preferred at this time.

In this preferred embodiment, the network administrator 16 checks the hardware performance of the chosen viewer 20 prior to finalizing its choice in order to determine whether the viewer's video hardware is sufficient to allow for substantially real time transmission of video data to and from the viewer 20 if chosen to participate in the broadcast. In the preferred method, this is accomplished by checking the hardware performance of all viewers 20 at login and only allowing conforming viewers to be chosen. In still others, the network administrator 16 will provide the user with specific hardware that is required to participate, and only viewers with this hardware will be allowed to be chosen.

The manner in which viewers 20 are chosen may take many forms. In some embodiments, viewers 20 are chosen at random by the network administrator 16. In others, a small number of viewers 20 are chosen as candidates and are subsequently interviewed by the broadcaster 18, who then makes the final choice of who participate in the program.

In the preferred embodiment, a candidate, or pool of candidates, is chosen from all viewers based upon their prior viewership of the broadcast, with those who have watched more frequently have a greater chance of being chosen to participate than those who are merely casual viewers of the broadcast. This method is preferred as it provides viewers with an added incentive to watch the program frequently, whether or not they have been chosen to participate. However, other methods of weighting may also be employed. For example, preference could be given to those viewers who had patronized sponsors of the program during past broadcasts. In such an embodiment, viewers would be encouraged to click on banner advertisements before, during or after broadcasts, in order to earn points toward participating in a future broadcast. By generating more clicks-through to the advertisers, the advertisers will experience a quantifiable increase in exposure and, consequently, the value of each advertisement will likewise be increased. In still others, viewers are chosen by logging onto a website, selecting a show, and answering questions are about the show and episodes. The people that get the most answers correct will win a chance to appear on the show, or to obtain an “audition”. In this way, viewers must watch almost every show in order to have an opportunity to be selected.

In some embodiments, there will be a website specially designed for interactive television, and the individual will log on to and tell the show that they are interested in appearing on the show. The website then will put them through a sequence of events that they will have to follow and this will determine if the person has what it takes to appear. The website will also explain what is needed for hardware, and that the software can be downloaded by the Internet provider for a fee or free, whatever the provider is offering. Hardware can also be rented or purchased to make participating easy. Website digital imaging via computer cam is become much better than it has in the past and can be fine lined enough by the Internet provider to produce pictures of adequate quality.

The method of the present invention is ideally suited for use with broadcasts of the game show genre, in which viewers compete for money or other prizes. These types of broadcasts are preferred, as they have proven ratings appeal, even absent the direct audience participation. Further, they will tend to draw additional viewers who are interested in winning the money or prizes to be awarded to participants. A wide variety of game show formats could benefit from the inclusion of remote viewer participation. For example, trivia type games, such as “Jeopardy” or “The Hollywood Squares” would be especially effective, with viewers pitting wits with each other and/or celebrity participants. However, other formats may likewise be adapted, and any show that has contestants and/or and audience is amendable to participation by a viewer using the method.

Further, because of the far reach of today's networks, and even further reach of future networks, this method could likewise have great impact on the field of news broadcasts, which could enlist viewers from around the world to provide insight into current events. In this method, each viewer is a virtual “correspondent”, able to be accessed and questioned about issues and events in their area. For example, viewers from one country could provide insight into the mood of the people in the face of an impending war, while viewers from other countries could explain their approval of, or opposition to, military action. However, this is but a single example, while the variety of options for viewer interaction in news broadcasts is nearly limitless.

Finally, the inventor envisions that the method of the present invention may be used in connection with programs in which alternative scenarios may be played out. For example, a plurality of viewers could be chosen to “direct” the action taking place in a scene, with each appearing on screen and choosing a particular direction for the action to take. This embodiment is easily implemented using the same techniques used to provide alternative endings and scenes in DVD-ROM titles such as “The Lord of the Rings: The Fellowship of the Ring”, “The Matrix” and others.

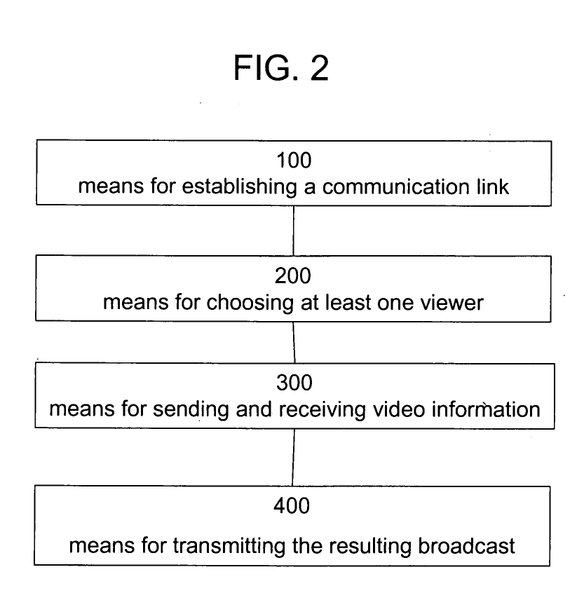

As noted above, the method for multimedia interaction of the present invention is readily adapted for execution by a computer program product. As shown in FIG. 2, the program product includes program means 100 for establishing a communication link between a plurality of viewers and broadcaster, program means 110 for choosing at least one viewer to appear on a broadcast, program means 120 for sending and receiving video information between a broadcaster and a chosen viewer, and program means 130 for transmitting the resulting broadcast to at least the plurality of viewers from which the chosen viewer or viewers were chosen.

Beyond the increases in viewership to be expected through the provision of such interactivity, the inventor likewise recognizes that the method provides a great business opportunity for the providers of network services. Accordingly, the inventor envisions that the method for multimedia interaction of the present invention will become part of a method for increasing network subscribership practiced by the network service providers.

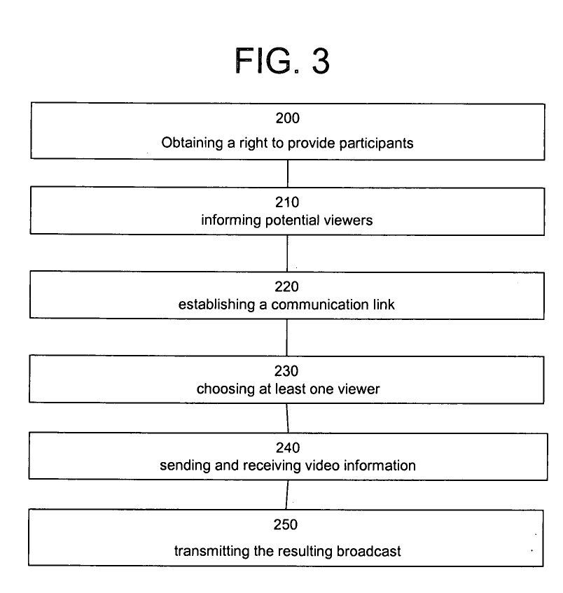

As shown in FIG. 3, the method for increasing network subscribership includes the step of obtaining a right to provide participants 200 to a broadcaster of a program and informing potential viewers 210 of the ability to participate in broadcasts of the program by subscribing to the network. The network provider then performs the method for method for multimedia interaction by establishing a communication link 220 between a plurality of viewers and broadcaster and choosing at least one viewer 230 to appear on a broadcast, sending and receiving video information 240 between the viewer and broadcaster, and transmitting the broadcast 250 to at least the plurality of viewers from which the chosen viewer or viewers were chosen.

In some embodiments of this method, the network provider will obtain the right to provide participants to a program by virtue of its likewise being the broadcaster of the program. In this manner, providers such as AOL or MSN could have their own interactive broadcast areas in which subscribers could participate in broadcasts viewed by other subscribers to the network. By excluding non-subscribers, these large providers can provide added incentive for potential viewers to subscribe, above what could be obtained through a lower cost provider, such as Juno or NetZero, and both increase subscribership and the cost of each subscription.

It is understood that the broadcasts to be provided are not necessarily television broadcasts, but rather could be webcasts or closed circuit broadcasts that are only accessible through the network. For example, in one embodiment, the broadcast is a casino or lottery game broadcast, run by a state lottery commission, licensed casino, or the like, which is broadcast on a closed circuit television network. In this embodiment, the network chooses viewers for inclusion in broadcasts over the network and allows all viewers to wager upon the outcome of the game being played.

This system could be readily adapted for use over the web, with viewers residing in a particular state being allowed to access the state lottery website and play the game along with others from that state in real time. For example, the state could have a “virtual Keno” parlor in which players wager from their computers and view others playing the game over the Internet.

It is envisioned that such a system would be ideal for use in hotels, which would have televisions equipped with the necessary video hardware to provide the desired level of real time communication to allow viewers to play casino or lottery games from the comfort and safety of their hotel rooms. In one such embodiment, the viewer would set up an account with the network provider from which wagers could be made, and would either enter to be chosen for broadcast, or decline to be chosen and simply view and play the game simultaneously with the chosen viewer. In some embodiments, multiple viewers may be chosen to play a game, such as poker, and the non-chosen viewers will be allowed to wager on the outcome. For example, the wager could involve choosing a winner prior to dealing the cards, or alternatively, by independently wagering based upon access to only a chosen player's hand. In others, such as roulette, craps, or the like, the viewer is allowed to choose numbers and view other players, and the roulette wheel or craps table, in the same manner as if they were present on the floor of the casino.

More important than any tentative profit picture for Internet providers or networks, the interactive television method of the present invention bring television out of the dark ages and into the 21^{st} century. By transporting a person's live image from any location to a television show, the actual outlook of any television show can be changed. The instant outside participation by one or more people from different walks of live throughout the country as well as the world provides cross-cultural opportunities that do not currently exist.

Game shows, diet shows, children shows, and a large number of different shows could be affected by being able to have interactive “live” input from their viewing audience. For example, a person is participating in “The Price is Right” live from his porch in Florida as if he is in the studio; selecting numbers and ringing bells though a computer as if he or she was right in the studio like the on-site contestants are. Bob Barker says “come on down”, well, now people can come on down not just from the audience, but all over the world! In addition, health shows or fitness shows can now put, via interactive TV, any of their audience on their show at any time to give verification of the product or package they are selling. If you stop and think of any show on television that has contestant or viewer participation in any way by phone, you have found shows that need the interactive television methods described herein! Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method for multimedia interaction between a broadcaster and a viewing audience comprising the steps of:
establishing a digital communication link between a plurality of viewers and said broadcaster;
selecting at least one participant from said plurality of viewers to appear on a broadcast;
transmitting digital information having both image content and audio content between said participant and said broadcaster; and
incorporating at least a portion of said digital information in said broadcast.

2. The method of claim 1 wherein said transmitting step comprises transmitting said digital information over a publicly accessible computer network.

3. The method of claim 1 wherein said establishing step comprises establishing a digital communication link through a limited-access virtual private computer network.

4. The method of claim 1 further comprising the step of recording at least a portion of said digital information for broadcast at a later point in time.

5. The method of claim 1 further comprising the step of broadcasting said at least a portion of said digital information in substantially real time.

6. The method of claim 1 further comprising the step of performing an analysis of said digital communication link between a plurality of viewers and said broadcaster prior to said selecting step.

7. The method of claim 6 wherein said selecting step comprises the step of selecting optimum viewers based upon a result of said analysis of said digital communication link between a plurality of viewers and said broadcaster.

8. The method of claim 7 wherein said selecting step further comprises the step of selecting optimum viewers based on compatibility with hardware maintained by said broadcaster.

9. The method of claim 1 wherein said selecting step comprises randomly selecting said at least one participant.

10. The method of claim 1 wherein said selecting step comprises the steps of creating a potential participant group based upon specific selection criteria and selecting said at least one participant from said potential participant group.

11. The method of claim 10 further comprising the step of tracking viewership of each broadcast by each of said plurality of viewers, and wherein said step of creating a potential participant group comprises the step of creating a potential participant group based upon viewership of prior broadcasts by each of said plurality of viewers.

12. The method of claim 10 further comprising the step of tracking patronization of sponsors of each broadcast by each of said plurality of viewers, and wherein said step of creating a potential participant group comprises the step of creating a potential participant group based upon prior patronization of said sponsors.

13. The method of claim 10 further comprising the steps of asking each of said plurality of viewers questions about prior broadcasts and compiling answers to said questions, and wherein said step of creating a potential participant group comprises the step of creating a potential participant group based upon a result of said compiling step.

14. The method of claim 13 wherein said step of asking each of said plurality of viewers questions about prior broadcasts comprises the step of displaying said questions on an Internet website and wherein said compiling step comprises the step of receiving answer data transmitted from said Internet website.

15. The method of claim 1 wherein said incorporating step comprises the steps of displaying said digital information on said broadcast and modifying said broadcast based upon said at least a portion of said digital information.

16. The method of claim 1 wherein said broadcast is one of a news broadcast and a game broadcast.

17. A computer program product for multimedia interaction between a broadcaster and a plurality of viewers, said computer program product comprising:
program means for establishing a communication link between said plurality of viewers and said broadcaster;
program means for choosing at least one viewer,to appear as a participant on a broadcast;
program means for sending and receiving digital image and audio information between said broadcaster and a chosen viewer; and
means for transmitting said broadcast to at least the plurality of viewers from which the chosen viewer or viewers were chosen.

18. A method for increasing a number of subscribers to a computer network, said method comprising the steps of:
obtaining an exclusive right to provide participants to a broadcast of a program;
informing a plurality of potential participants of an ability to participate in said broadcast of said program by subscribing to said computer network;
establishing a digital communication link through said computer network between a plurality of subscribers and said broadcaster;
selecting at least one participant from said plurality of subscribers to participate on said broadcast of said program;
transmitting digital information having both image content and audio content between a chosen participant and said broadcaster; and
incorporating at least a portion of said digital information into said broadcast.

19. The method of claim 18 wherein said computer network is a casino computer network, wherein said program is a interactive gambling program broadcast on a closed circuit television network in a casino.

20. The method of claim 19 wherein said potential participants are gamblers and wherein said network is adapted to allow both participants and non-participants to gamble remotely therethrough.
